(19) United States
(12) Patent Application Publication
(10) Pub. No.: US 2014/0223749 A1
(43) Pub. Date: Aug. 14, 2014

(54) BLADE REPLACEABLE HACKSAW

(71) Applicant: YIN HAN HUANG, Taichung City (TW)

(72) Inventor: YIN HAN HUANG, Taichung City (TW)

(21) Appl. No.: 13/763,722

(22) Filed: Feb. 10, 2013

(51) Int. Cl. B23D 49/12

(52) U.S. Cl. CPC B23D 49/12
USPC 30/510

(57) ABSTRACT

A blade replaceable hacksaw includes a spine with a handle connected thereto. A tension adjustor and a first blade securing portion are connected to the first and second ends of the spine. A positioning block is pivotably connected to the second end of the spine and a second blade securing portion is formed to the positioning block. A protrusion extends from the first end of the positioning block. A stop is connected to the second end of the spine and has an inclined face and a top face. When the positioning block is pivoted upward and supported on the inclined face, a first blade is connected between the first blade securing portion and the tension adjustor. When the positioning block is pivoted downward and the protrusion contacts the stop face of the stop, a second blade is connected between the second blade securing portion and the tension adjustor.

### FIELD OF THE INVENTION

The present invention relates to a hacksaw, and more particularly, to a blade replaceable hacksaw so as to use two different lengths of hacksaw blades.

### BACKGROUND OF THE INVENTION

The conventional hacksaw generally comprises a spine and a handle which is connected to the first end of the spine. A hacksaw blade is connected between two ends of the spine. For the hacksaw using a fixed length blade, a tension adjustor is connected to the first end of the spine and a securing member is connected to the second end of the spine. The two ends of the blades are respectively connected to the tension adjustor and the securing member. The tension of the blade can be adjusted by operation to the tension adjustor.

For the hacksaw using different lengths of blades, a tension adjustor is connected to the first end of the spine and a positioning block is connected to the second end of the spine. The two ends of the blades are respectively connected to the tension adjustor and the positioning block. Due to the fixed length of the spine, the range of the lengths of the blades is limited. It is noted that the positioning block should not interfere the securing of the blade.

The present invention intends to provide a blade replaceable hacksaw wherein the positioning block can be pivotably connected to the spine and does not interfere the installation of the blade.

### SUMMARY OF THE INVENTION

The present invention relates to a blade replaceable hacksaw and comprises a spine with a handle connected thereto. A tension adjustor is connected to the first end of the spine and a first blade securing portion is connected to the second end of the spine. A positioning block is pivotably connected to the second end of the spine and a second blade securing portion is formed to the positioning block. A protrusion extends from the rear wall of the first end of the positioning block. A stop is connected to the second end of the spine and has an inclined face and a top face. When the positioning block is pivoted upward and supported on the inclined face of the stop. Two ends of a first blade are respectively connected to the first blade securing portion and the tension adjustor. When the positioning block is pivoted downward and the protrusion contacts the stop face of the stop, two ends of a second blade are respectively connected to the second blade securing portion and the tension adjustor.

The primary object of the present invention is to provide a hacksaw which has a first blade securing portion and a second blade securing portion which is functioned by using a positioning block. A first blade is connected between the first blade securing portion and the tension adjustor. A second blade is connected between the second blade securing portion and the tension adjustor. The second blade is longer than the first blade.

The positioning block is pivotably connected to the second end of the spine and does not interfere the installation of the first blade when the positioning block is pivoted upward and accommodated in the space in the second end of the spine. Similarly, when installing the second blade, the first blade securing portion does not interfere the second blade.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hacksaw of the present invention wherein the first blade is installed;

FIG. 2 is a plan view to show the hacksaw as shown in FIG. 1;

FIG. 3 is a perspective view to show the hacksaw of the present invention wherein the second blade is installed;

FIG. 4 is a plan view to show the hacksaw as shown in FIG. 3;

FIG. 5 is an exploded view, from the front end of the positioning block, to show the second blade securing portion of the hacksaw of the present invention;

FIG. 6 is an exploded view, from the rear end of the positioning block, to show the second blade securing portion of the hacksaw of the present invention;

FIG. 7 shows that the second blade is connected to the positioning block of the second blade securing portion;

FIG. 8 is a plan view to show the second blade connected to the positioning block of the second blade securing portion;

FIG. 9 shows that the first blade is connected to the first blade securing portion while the positioning block is accommodated in the space of the spine, and

FIG. 10 is a plan view to show the first blade connected to the first blade securing portion while the positioning block is rested on the inclined face of the stop.

### DETAILED DESCRIPTION OF THE PREFERRED EMBODIMENT

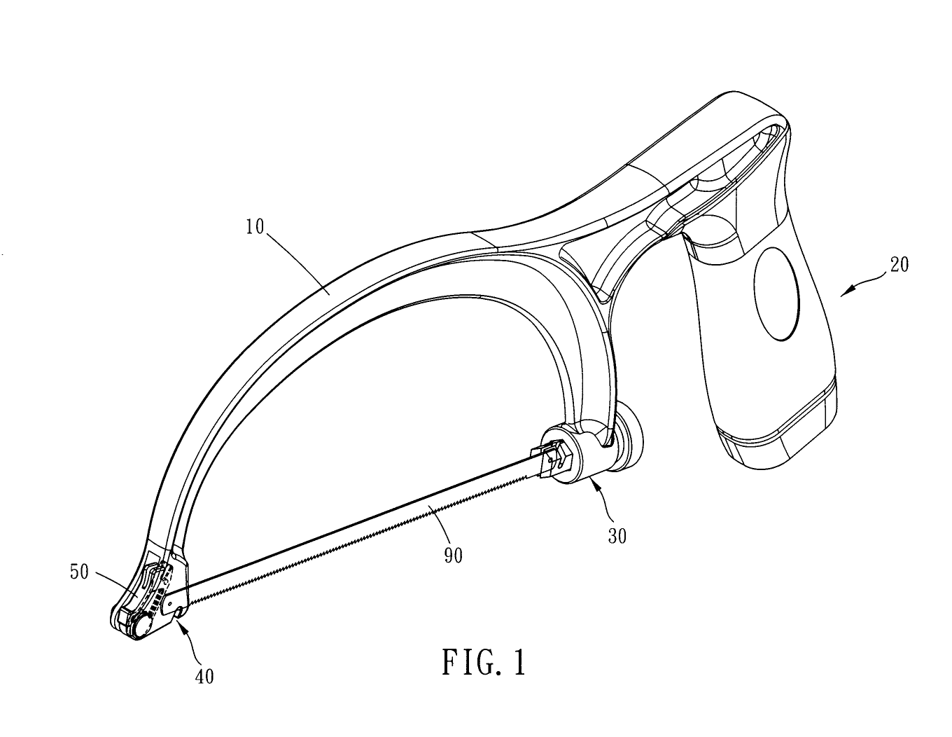

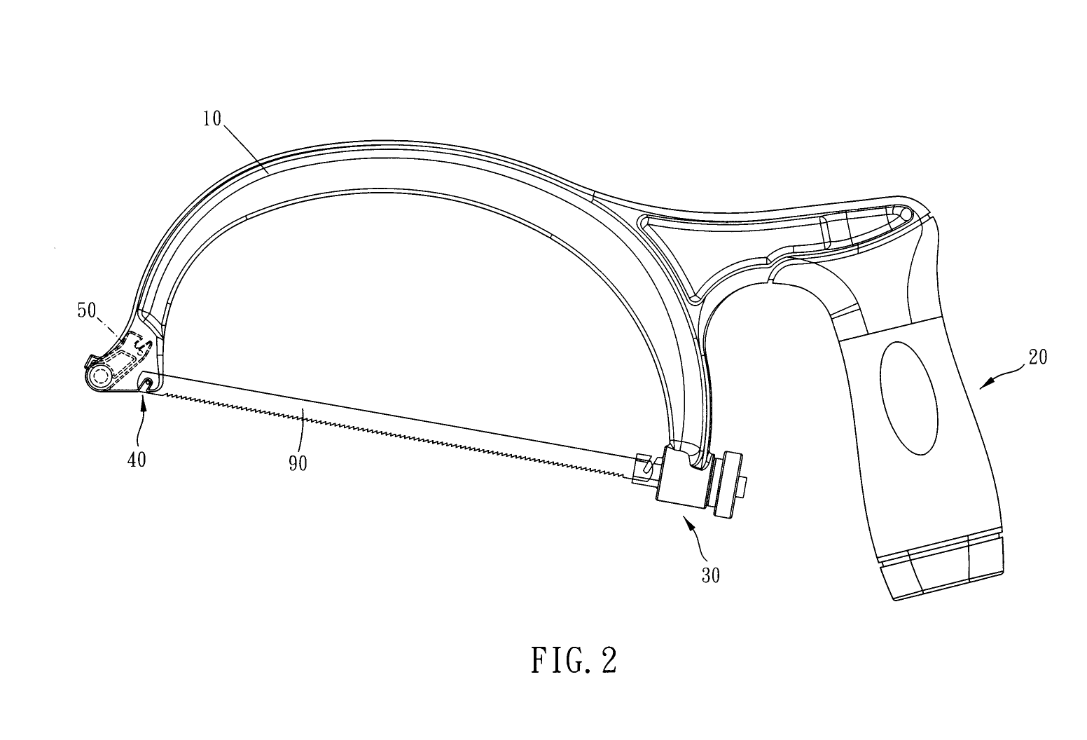

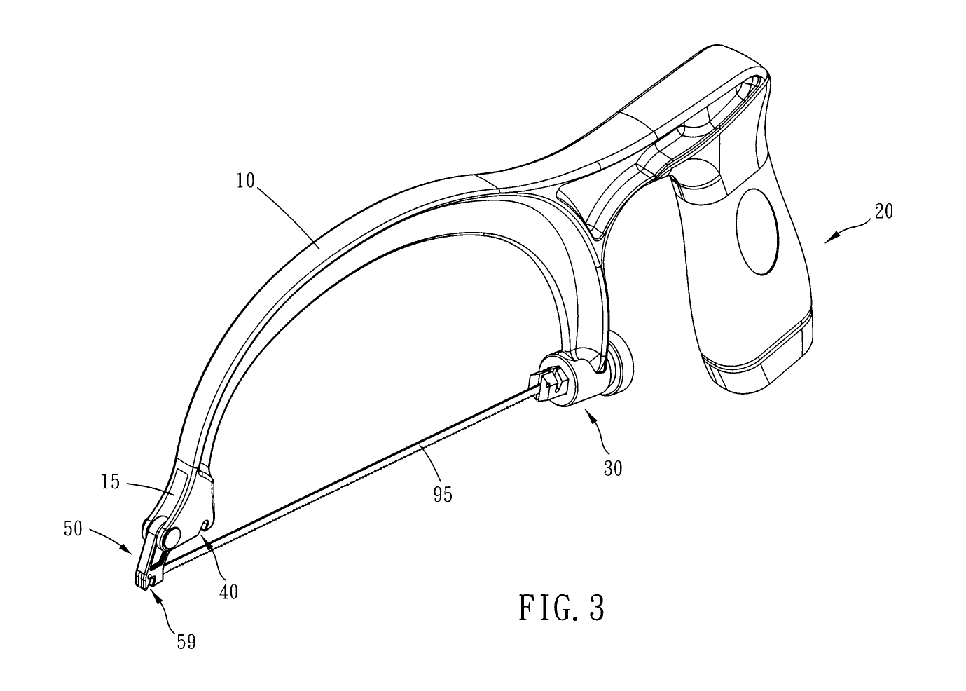

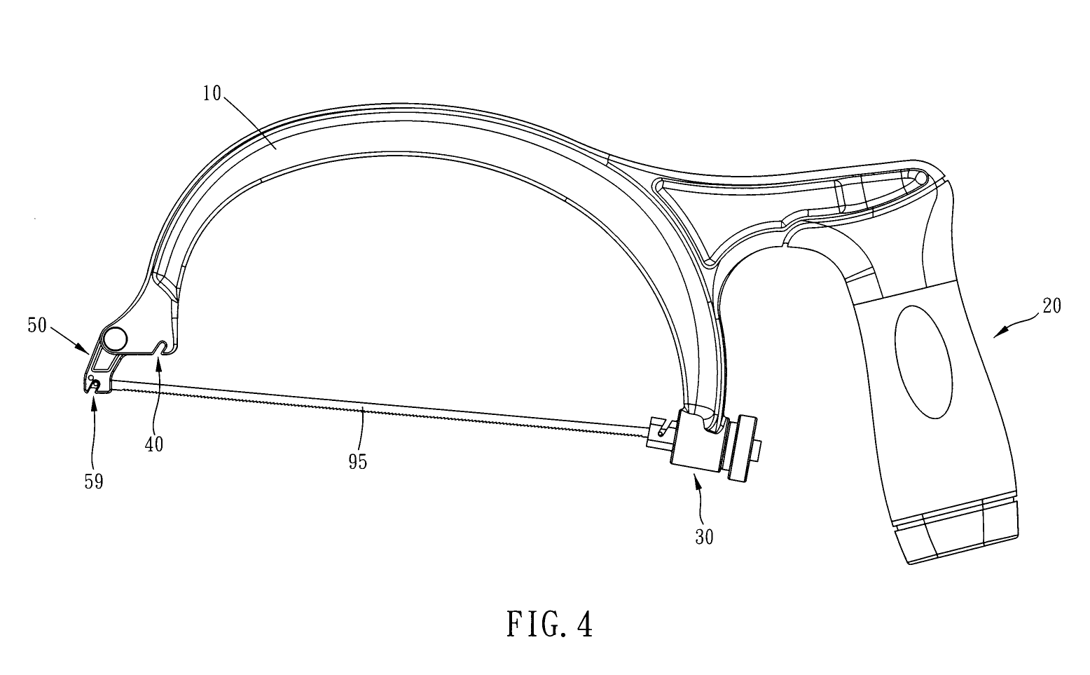

Referring to FIGS. 1 to 4, the hacksaw of the present invention comprises a spine 10 and a handle 20 is connected to the spine 10. The spine 10 has a first end and a second end, and a tension adjustor 30 is connected to the first end of the spine 10. A first blade securing portion 40 is connected to a rear portion of the second end of the spine 10. A positioning block 50 has the first end thereof pivotably connected to a front portion of the second end of the spine 10 by a pivot 55. Two ends of a first blade 90 are respectively connected to the first blade securing portion 40 and the tension adjustor 30. The second end of the positioning block 50 has a second blade securing portion 59 formed thereto. A protrusion 58 extends from the rear wall 54 of the first end of the positioning block 50. Two ends of a second blade 95 are respectively connected to the second blade securing portion 59 and the tension adjustor 30. The second blade 95 is longer than the first blade 90.

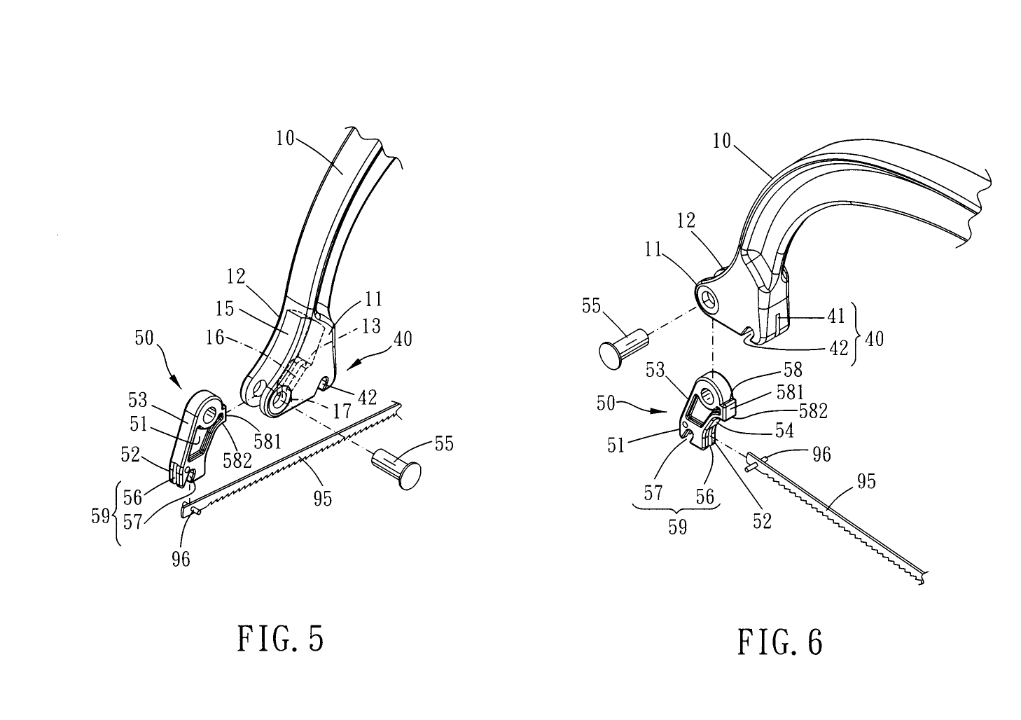

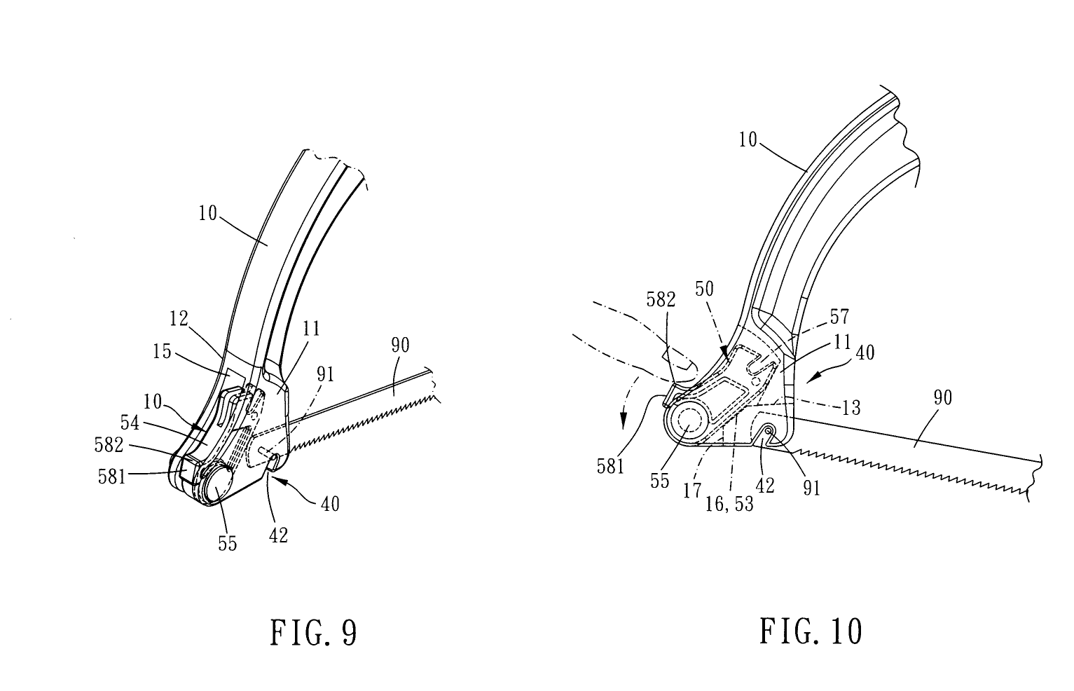

As shown in FIGS. 5 and 6, the second end of the spine 10 has a first sidewall 11 and a second sidewall 12 which is parallel to the first sidewall 11. A space 15 is defined between the first and second sidewalls 11, 12, and the positioning block 50 is accommodated in the space 15 when the positioning block 50 is pivoted upward. A stop 13 is connected to the second end of the spine 10 and located at a rear end of the positioning block 50. The first blade securing portion 40 has a first slit 41 defined in the stop 13 and opens backward and downward. A first notch 42 is defined through the stop 13, the first sidewall 11 and the second sidewall 12. The first notch 42 opens downward. As shown in FIGS. 9 and 10, the first end of the first blade 90 is inserted into the first slit 41 from the bottom of the stop 13 and the two pins 91 on two sides of the first blade 90 are engaged with the first notch 42. The second end of the first blade 90 is connected to the tension adjustor 30 which is operated to provide proper tension to the first blade 90. The first blade securing portion 40 is formed by the first slit 41 and the first notch 42.

The positioning block 50 comprises a left wall 51, a right wall 52, a front wall 53 and the rear wall 54. The first end of the positioning block 50 is pivotably connected between the first and second sidewalls 11, 12 by the pivot 55. The second end of the positioning block 50 has the second blade securing portion 59 which has a second slit 56 defined in the positioning block 50. The second slit 56 opens downward and rearward. A second notch 57 is defined through the left wall 51 and the right wall 52 of the positioning block 50 and opens to the second end of the positioning block 50. The positioning block 50 has a protrusion 58 which extends from the rear wall 54. The protrusion 58 has a stop face 581 and a ridge 582.

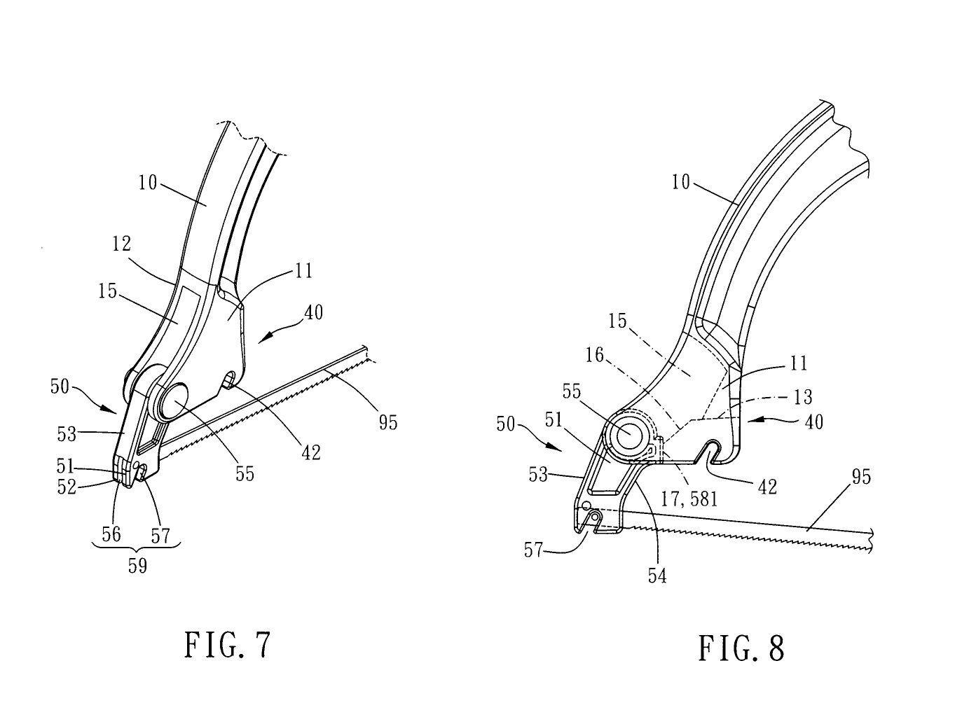

The positioning block 50 can be pivoted upward and accommodated in the space 15 as shown in FIGS. 9 and 10, or the positioning block 50 can be pivoted downward to protrude from the second end of the spine 10 as shown in FIGS. 7 and 8.

As shown in FIGS. 5, 9 and 10, the stop 13 has an inclined face 16 and a top face 17. When the positioning block 50 is pivoted upward and received in the space 15, the front wall 53 of the positioning block 50 is supported on the inclined face 16 of the stop 13, so that the positioning block 50 does not pivot downward. The two ends of the first blade 90 are respectively connected to the first blade securing portion 40 and the tension adjustor 30. The positioning block 50 does not interfere the first blade 90. Besides, when the positioning block 50 is accommodated in the space 15, the ridge 582 protrudes from the second end of the spine 10 such that the user may pivot the positioning block 50 by pushing the ridge 582 downward.

As shown in FIGS. 7 and 8, when the positioning block 50 is pivoted downward and the stop face 581 of the protrusion 58 on the positioning block 50 contacts the stop face 17 of the stop 13, the second blade 95 is inserted into the second slit 56 and the two pins 96 on two sides of the second blade 95 are engaged with the second notch 57. Therefore, the two ends of the second blade 95 are respectively connected to the second blade securing portion 59 and the tension adjustor 30. The stop face 17 of the stop 13 supports the positioning block 50, so that the positioning block 50 can bear the pull force when adjusting the tension of the second blade 95, and the second blade 95 does not change its angle.

The second slit 56 and the second notch 57 are located below the first blade securing portion 40 so that the first blade securing portion 40 does not interfere the installation of the second blade 95.

While we have shown and described the embodiment in accordance with the present invention, it should be clear to those skilled in the art that further embodiments may be made without departing from the scope of the present invention.

What is claimed is:

1. A blade replaceable hacksaw comprising:
a spine having a first end and a second end, a handle connected to the spine and a tension adjustor connected to the first end of the spine;
a first blade securing portion connected to a rear portion of the second end of the spine;
a positioning block having a first end thereof pivotably connected to a front portion of the second end of the spine by a pivot, a second end of the positioning block having a second blade securing portion formed thereto, a protrusion extending from a rear wall of the first end of the positioning block, and
a stop connected to the second end of the spine and located at a rear end of the positioning block, the stop having an inclined face and a top face, when the positioning block is pivoted upward and supported on the inclined face of the stop, two ends of a first blade are respectively connected to the first blade securing portion and the tension adjustor, when the positioning block is pivoted downward and the protrusion on the positioning block contacts the stop face of the stop, two ends of a second blade are respectively connected to the second blade securing portion and the tension adjustor.

2. The hacksaw as claimed in claim 1, wherein the second end of the spine has a first sidewall and a second sidewall which is parallel to the first sidewall, a space is defined between the first and second sidewalls, the positioning block is accommodated in the space when the positioning block is pivoted upward.

3. The hacksaw as claimed in claim 2, wherein the first blade securing portion has a first slit defined in the stop and opens backward and downward, a first notch is defined through the stop, the first sidewall and the second sidewall, the first notch opens downward.

4. The hacksaw as claimed in claim 1, wherein the second blade securing portion has a second slit defined in the positioning block, a second notch is defined through left wall and right wall of the positioning block and opens to the second end of the positioning block.

5. The hacksaw as claimed in claim 1, wherein the protrusion has a stop face and a ridge, when the positioning block is pivoted downward, the positioning block contacts the stop face of the stop, when the positioning block is pivoted upward, the ridge protrudes from the second end of the spine.

6. The hacksaw as claimed in claim 1, wherein the second blade is longer than the first blade.
